(19) United States
(12) Patent Application Publication
(10) Pub. No.: US 2004/0264164 A1
(43) Pub. Date: Dec. 30, 2004

(54) Reflector for a backlight module of flat panel display

(75) Inventors: Cheng-Min Liao, Jhongli City (TW); An-Ching Yen, YinggeTownship (TW)

Correspondence Address: BACON & THOMAS, PLLC, 625 SLATERS LANE, FOURTH FLOOR, ALEXANDRIA, VA, 22314

(73) Assignee: Chunghwa Picture Tubes, Ltd., Taipei City (TW)

(21) Appl. No.: 10/874,272

(22) Filed: Jun. 24, 2004

(30) Foreign Application Priority Data
Jun. 27, 2003 (TW) 092117583

(51) Int. Cl. F21V 7/04

(52) U.S. Cl. 362/31

(57) ABSTRACT

The present invention is concerned with a reflector for a backlight module of a flat panel display fitted with at least one light source connected to at least one cable, and includes a reflecting shell having a groove for receiving the light source emitting a light to be reflected from the groove, and at least one cable holding member having a cross-sectional area in the shape of a “U” or an “L” integrated with the periphery of a lateral wall of the reflecting shell for receiving the cable connected to the light source; wherein the cable is separated from the light source by means of the lateral wall integrated with the cable holding member. Also, a method for assembling backlight module of flat panel displays is disclosed.

### BACKGROUND OF THE INVENTION

1. Field of the Invention

The present invention relates to a reflector, and more particularly, to a reflector suited for a backlight module of a flat panel display.

2. Description of Related Art

As shown in FIG. 1, a conventional backlight module of a flat panel display has a light source (such as a lamp) 50, a reflector 60, and a cable 70; wherein voltage is supplied to the lamp 50 by means of the cable to generate a visible light while light emitting from the lamp by means of the reflector is reflected toward a predetermined direction so as to increase luminance.

In general, a backlight module is assembled by the following steps: First, a lamp having a cable is fixedly mounted into a reflector. Then, a double-sided adhesive tape is attached directly to the lamp reflector. Finally, the lamp cable is adhered to the double-sided adhesive tape. Alternatively, the lamp having the cable is fixedly mounted into the reflector; and then, the lamp cable is fixedly mounted on the reflector with an adhesive tape. Both of the fixing manners are known to result in the following disadvantages: (A) the cable will no longer be positioned in its pristine condition when the adhesion strength of the double-sided or single-sided adhesive tape by which the lamp cable is attached to the lamp reflector weakens; and (B) it is inconvenient for the operating laborers to manually use the double-sided or single-sided adhesive tape for fixing the cable to a position, which is generally not predetermined.

Therefore, it is desirable to provide a reflector for a backlight module of a flat panel display to mitigate and/or obviate the aforementioned problems.

### SUMMARY OF THE INVENTION

It is therefore a primary object of the present invention to provide a reflector for a backlight module of a flat panel display to simplify a cable-fixing process, dispense with double-sided or single-sided adhesive tape for securing the cable connected to a light source, and increase both assembly convenience by manual labor and assembly efficiency of backlight module by setting out a groove for holding the cable on the reflector.

Another object of the present invention is to provide a method for assembling a backlight module of a flat panel display so as to dispense with double-sided or single-sided adhesive tape and increase not only assembly convenience by manual labor but also assembly efficiency of the backlight module.

To attain the aforesaid objects, a reflector for a backlight module of a flat panel display according to the present invention is fitted with at least one light source connected to at least one cable, comprising a reflecting shell having a groove for receiving the light source emitting a light to be reflected from the groove, and at least one cable holding member having a cross-sectional area in the shape of a “U” or an “L” integrated with the periphery of a lateral wall of the reflecting shell for receiving the cable connected to the light source; wherein the cable is separated from the light source by means of the lateral wall integrated with the cable holding member.

To attain the aforesaid objects, a method for assembling a backlight module of a flat panel display according to the present invention comprises the following steps: (A) providing at least one light source connected to at least one cable, at least one cable holding member having a groove for receiving the light source emitting a light to be reflected from the groove, and a reflecting shell having a cross-sectional area in the shape of a “U” or an “L” integrated with the periphery of a lateral wall of the reflecting shell for receiving the cable connected to the light source separated from the cable by means of the lateral wall integrated with the reflecting shell; (B) disposing the light source into the reflecting shell of the light source reflector; and (C) disposing the cable into the cable holding member of the light source reflector.

It is preferable for the cable holding member to be integrated with the reflecting shell in the reflector for a backlight module of a flat panel display according to the present invention, and more preferably, the cable holding member and the reflecting shell are integrally formed by stamping; wherein the reflecting shell has a cross-sectional area in the shape of a “U” or a semicircle for enclosing the light source at intervals. A layer of anti-reflection or UV material is preferably coated over the surface of the reflecting shell opposite to the light source. A groove capable of receiving the cable is formed between the cable holding member and the lateral wall of the reflecting shell to either continuously or non-continuously hold the cable, depending on the design thereof. The cable holding member is in the shape of a “U” having two parallel lateral walls spaced sufficiently apart for sandwiching the at least one cable.

The method for assembling a backlight module of a flat panel display according to the present invention at step (C) preferably comprises a pre-process of: attaching a double-sided adhesive tape to the cable holding member to adhere the cable fixedly to the cable holding member of the reflector at step (C1); or alternatively, a post-process of: adhering the cable of the reflector with an adhesive tape to prevent the cable from detachment at step (D1). The method for assembling a backlight module dispenses with a single-sided or double-sided adhesive tape by providing a U-shaped cable holding member having two parallel lateral walls spaced sufficiently apart for sandwiching the cable. The light source of the present method is not specifically defined, and can be a fluorescent tube or an LED lamp.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional view of a conventional backlight module;

FIG. 2 is a cross-sectional view of a preferred embodiment of a backlight module according to the present invention;

FIG. 3 is a perspective view of a first preferred embodiment of a backlight module according to the present invention;

FIG. 4 is a cross-sectional view of a second preferred embodiment of a backlight module according to the present invention; and

FIG. 5 is a cross-sectional view of a third preferred embodiment of a backlight module according to the present invention.

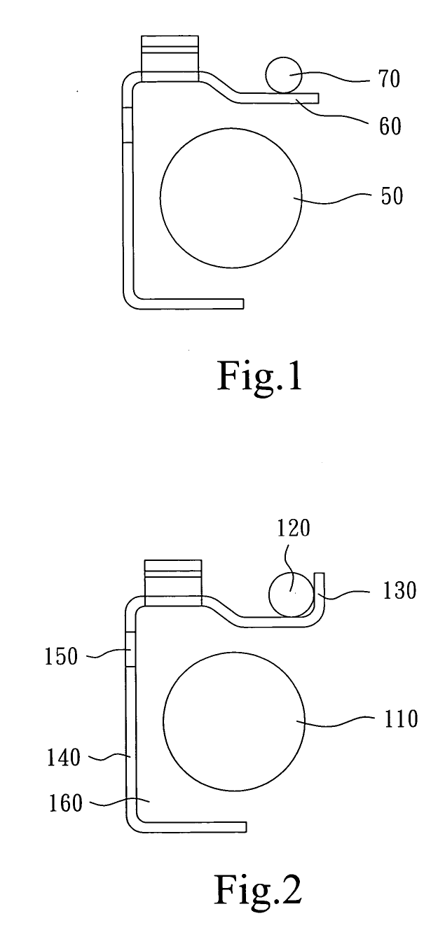

### DETAILED DESCRIPTION OF THE PREFERRED EMBODIMENT

### First Embodiment

The method for assembling a backlight module of a flat panel display according to the present embodiment adopts a reflector and a light source (lamp) as shown in the cross-sectional view of FIG. 2. The present embodiment is assembled by the following steps. First, a lamp 110 connected to a cable 120 as well as a reflector 150 having a cable holding member 130 and a reflecting shell 140 are provided; wherein the reflecting shell 140 has a groove 160 having a cross-sectional area in the shape of a “U” with an acute angle inside for receiving the lamp 110. A layer of anti-reflection or UV material is then coated over the surface of the reflecting shell 140 opposite to the lamp 110 to cause a light emitting from the lamp 110 to be reflected from the groove 160. The cable holding member 130 has a cross-sectional area in the shape of an “L”, being integrated with the periphery of a lateral wall of the reflecting shell 140. Because the cable holding member 130 is an integrated component, a continuous groove for receiving the cable 120 of the lamp 110 is formed between the cable holding member 130 and the lateral wall of the reflecting shell 140. The cable 120 is separated from the lamp 110 by means of the integrated lateral wall of the reflecting shell. In addition, the cable holding member 130 is integrated with the reflecting shell 140 by stamping. In assembly, the lamp 110 is further disposed into the reflecting shell 140 of the reflector 150, and then, the cable 120 is disposed into the cable holding member 130 of the reflector 150. Finally, the cable 120 and the cable holding member 130 of the reflector 150 are bound together by means of an adhesive tape.

### Second Embodiment

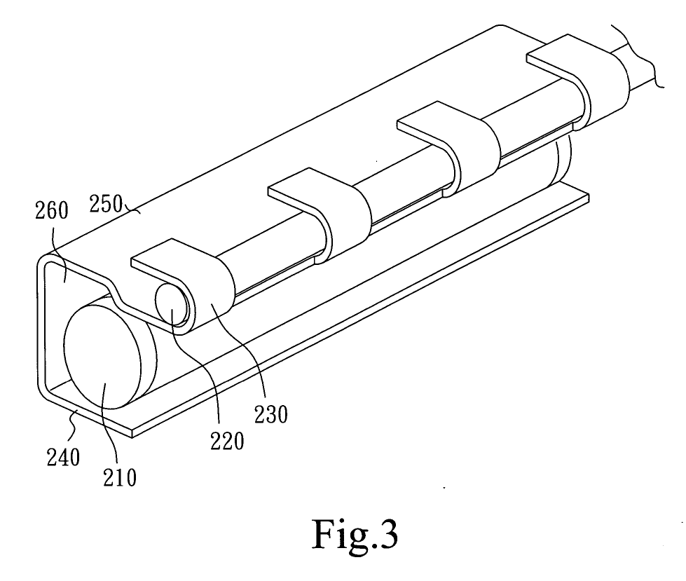

Similar to the structure and method as described in the first embodiment, a method for assembling a backlight module of a flat panel display according to the present embodiment adopts an assembly of a reflector and a light source as shown in FIG. 3. The present embodiment is assembled by the following steps. First, a lamp 210 connected to a cable 220 as well as a reflector 250 having a cable holding member 230 and a reflecting shell 240 are provided; wherein the reflecting shell 240 has a groove 260 having a cross-sectional area in the shape of a “U” with an acute angle inside for receiving the lamp 210. A layer of anti-reflection or UV material is then coated over the inner surface of the groove 260 opposite to the lamp 210 to cause a light emitting from the lamp 210 to be reflected from the groove 260. The cable holding member 230 has a cross-sectional area in the shape of a “U”, being integrated with the periphery of a lateral wall of the reflecting shell 240. In the present embodiment, the cable holding member 230 has a non-continuous groove, having two parallel lateral walls spaced sufficiently apart for sandwiching the cable 220 at intervals because of the “U”-shaped design. The cable 220 is separated from the lamp 210 by means of the integrated lateral wall of the reflecting shell. In addition, the cable holding member 230 is integrated with the reflecting shell 240 by stamping. In the present embodiment, the cable holding member 230 adopts the non-continuous groove to hold the cable at lower material cost. In assembly, the lamp 210 is further disposed into the reflecting shell 240 of the reflector 250, and then, the cable 220 is disposed into the groove of the cable holding member 230 of the reflector 250.

### Third Embodiment

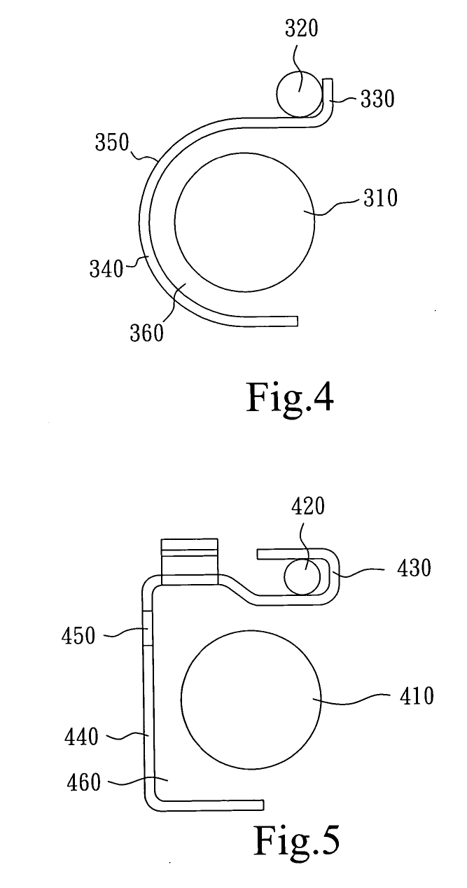

A method for assembling a backlight module of a flat panel display according to the present embodiment adopts a reflector and a light source (lamp) as shown in the cross-sectional view of FIG. 4. The present embodiment is assembled by the following steps. First, a lamp 310 connected to a cable 320 as well as a reflector 350 having a cable holding member 330 and a reflecting shell 340 are provided; wherein the reflecting shell 340 has a groove 360 having a cross-sectional area in the shape of a “U” for receiving the lamp 310. A layer of anti-reflection or UV material is then coated over the surface of the reflecting shell 340 opposite to the lamp 310 to cause a light emitting from the lamp 310 to be reflected from the groove 360. The cable holding member 330 has a cross-sectional area in the shape of an “L”, being integrated with the periphery of a lateral wall of the reflecting shell 340. The groove is continuous for receiving the cable 320 connected to the lamp 310. The cable 320 is separated from the lamp 310 by means of the integrated lateral wall of the reflecting shell. In addition, the cable holding member 330 is integrated with the reflecting shell 340 by stamping. In assembly, the lamp 310 is further disposed into the reflecting shell 340 of the reflector 350, and then, a double-sided adhesive tape is attached to the cable holding member 330 of the reflector 350. Finally, the cable 320 is adhered to the cable holding member 330 of the reflector 350 by means of double-sided adhesive tape.

### Fourth Embodiment

A method for assembling a backlight module of a flat panel display according to the present embodiment adopts a reflector and a light source (lamp) as shown in the cross-sectional view of FIG. 5. The present embodiment is assembled by the following steps. First, a lamp 410 connected to a cable 420 and a reflector 450 having a cable holding member 430 as well as a reflecting shell 440 are provided; wherein the reflecting shell 440 has a groove 460 having a cross-sectional area in the shape of a “U” with an acute angle inside for receiving the lamp 410. A layer of anti-reflection or UV material is then coated over the surface of the reflecting shell opposite to the lamp 410 to cause a light emitting from the lamp 410 to be reflected from the groove 460. The cable holding member 430 has a cross-sectional area in the shape of a “U” with an acute angle inside, being integrated with the periphery of a lateral wall of the reflecting shell 440. The groove is continuous, having two parallel lateral walls spaced sufficiently apart for sandwiching the cable 420 because of the “U”-shaped design. The cable 420 is separated from the lamp 410 by means of the integrated lateral wall of the reflecting shell. In addition, the cable holding member 430 is integrated with the reflecting shell 440 by stamping. In assembly, the lamp 410 is further disposed into the reflecting shell 440 of the reflector 450, and then, the cable 420 is disposed into the cable holding member 430 of the reflector 450.

The present invention primarily provides methods for fixing the lamp cable onto the reflector to reduce the problems associated with the adhesion strength of the double-sided adhesive tape or even to completely dispense with the adhesive. Furthermore, due to the design of the groove for holding the cable on the reflector, both assemblies convenience for attaching the double-sided or single-sided adhesive tape by manual labor and assembly efficiency of backlight module can be increased.

Although the present invention has been explained in relation to its preferred embodiments, it is to be understood that many other possible modifications and variations can be made without departing from the spirit and scope of the invention as hereinafter claimed.

What is claimed is:

1. A reflector for a backlight module of a flat panel display device fitted with at least one light source connected to at least one cable, comprising:
a reflecting shell having a groove for receiving said light source emitting a light to be reflected from said groove; and
at least one cable holding member having a cross-sectional area in a shape of a semicircle, a “U”, an “S”, or an “L”, said cable holding member is integrated with the periphery of a lateral wall of said reflecting shell for receiving said cable connected to said light source;
wherein said cable is separated from said light source by means of said lateral wall of said reflecting shell or of said integrated cable holding member.

2. The reflector of claim 1, wherein said cable holding member is integrated with said reflecting shell.

3. The reflector of claim 1, wherein said groove capable of receiving said cable is formed between said cable holding member and said lateral wall of said reflecting shell to hold said cable in a continuous manner.

4. The reflector of claim 1, wherein said groove capable of receiving said cable is formed between said cable holding member and said lateral wall of said reflecting shell to hold the cable in a non-continuous manner.

5. The reflector of claim 1, wherein said reflecting shell has a cross-sectional area in the shape of a “U” or a semicircle.

6. The reflector of claim 1, wherein said reflecting shell and said integrated cable holding member are formed by stamping.

7. The reflector of claim 1, wherein said cable holding member is in the shape of a “U” having two parallel lateral walls spaced sufficiently apart for sandwiching at least one cable.

8. The reflector of claim 1, wherein a layer of anti-reflection or UV material is coated over the surface of said reflecting shell opposite to said light source.

9. The reflector of claim 1, further comprising an adhesive for holding said cable wherein said adhesive is disposed between said cable and said cable holding member.

10. The reflector of claim 9, wherein said adhesive is a double-sided adhesive tape.

11. The reflector of claim 1, wherein said outer surface of said cable is fixed to said cable holding member in the shape of an “L” by means of an adhesive tape.

12. A method for assembling a backlight module of a flat panel display device, comprising the following steps:
(A) providing at least one light source connected to at least one cable, at least one cable holding member having a groove for receiving said light source emitting a light to be reflected from said groove, and a reflecting shell having a cross-sectional area in the shape of a semicircle, a “U”, an “S” or an “L” integrated with the periphery of a lateral wall of said reflecting shell for receiving said cable connected to said light source separated from said cable by means of said lateral wall integrated said the reflecting shell;
(B) disposing said light source into said reflecting shell of said reflector; and
(C) disposing said cable into said cable holding member of said reflector.

13. The method of claim 12, wherein said groove capable of receiving said cable is formed between said cable holding member and said lateral wall of said reflecting shell to hold said cable in a continuous manner.

14. The method of claim 12, wherein said groove capable of receiving said cable is formed between said cable holding member and said lateral wall of said reflecting shell to hold the cable in a non-continuous manner.

15. The method of claim 12, wherein said reflecting shell has a cross-sectional area in the shape of a “U” or a semicircle.

16. The method of claim 12, wherein said reflecting shell and said integrated cable holding member are formed by stamping.

17. The method of claim 12, wherein said cable holding member is in the shape of a “U” having two parallel lateral walls spaced sufficiently apart for sandwiching at least one cable.

18. The method of claim 12, wherein a layer of anti-reflection or UV material is coated over the surface of said reflecting shell opposite to said light source.

19. The method of claim 12, further comprising a pre-process at said step (C): attaching a double-sided adhesive tape to said cable holding member to adhere said cable fixedly to said cable holding member of said reflector at step (C1).

20. The method of claim 12, further comprising a post-process at step (C): adhering said cable of said reflector with an adhesive tape to prevent said cable from detachment at step (D1).
